(19) United States
(12) Patent Application Publication
(10) Pub. No.: US 2007/0273057 A1
(43) Pub. Date: Nov. 29, 2007

(54) Night Vision Light Filter

(76) Inventors: Soyer Francoise, Villebon S/Yvette (FR); Pierre Le Barny, Orsay (FR); Laurent Divay, Ivry-Sur-Seine (FR)

Correspondence Address: LOWE HAUPTMAN & BERNER, LLP, 1700 DIAGONAL ROAD, SUITE 300, ALEXANDRIA, VA, 22314, US

(21) Appl. No.: 11/547,781

(22) PCT Filed: Mar. 7, 2005
(86) PCT No.: PCT/EP05/51014

§ 371 Date: Oct. 5, 2006

(30) Foreign Application Priority Data
Apr. 9, 2004 (FR) 04 03767

(51) Int. Cl. B29D 11/00; C08F 2/44; C08F 2/50; G02B 5/22

(52) U.S. Cl. 264/1.38

(57) ABSTRACT

Process for the manufacture of a light filter compatible with night vision goggles having at least the following stages: preparation of a homogeneous solution comprising one monomer, one dye; one photoinitiator; photochemical crosslinking by ultraviolet radiation of the solution in the film form; annealing the photocrosslinked film.

### FIELD OF THE INVENTION

The invention relates to display systems compatible with night vision goggles and in particular to an optical light filter for the display system.

### BACKGROUND OF THE INVENTION

Pilots use night vision goggles (NVG) for night flying, in particular of aircraft such as planes or helicopters.

Night vision goggles comprise two identical goggle bodies placed in front of each eye of the pilot. Each body comprises essentially an objective lens, an electronic amplifying device and an eyepiece.

FIG. 1 shows the various light sources received by night vision goggles 10 used by a pilot 12 in the cockpit of a plane. The goggles receive mainly light rays 14 from the area targeted by the pilot, for example originating from the ground over which he is flying. The cockpit of the plane comprises flight (or display) instruments 16 having an illumination emitting light in the visible spectrum. Light rays 18 emitted by the instruments are received directly by the eyes 20 of the pilot and other light rays 22 resulting from the same instruments are in the same way received by the night vision goggles

The night vision goggles amplify the light (light rays 14) originating from the area targeted by the pilot in a spectral band corresponding to the red and the very near infrared, i.e. optical wavelengths situated between 650 and 930 nanometers. The gain of the goggles in this band of optical frequencies is huge, of the order of 10 000. It is thus important for the illumination of the flight instruments positioned in the cockpit to emit very little light in the band in which the goggles are amplified in order not to interfere with their operation and damage their performance. Of course, the flight instruments have to remain directly visible to the pilot and thus have to emit sufficient light in the remainder of the visible spectrum.

The illumination of the flying instruments emitting in the visible region and virtually not in the red or near infrared region is described as “NVG compatible” and forms the subject of standards, in particular a United States standard MIL-L-85762A, which defines, inter alia, the acceptable colors and in particular the ratio of the energy emitted in the spectrum in which the goggles are amplified to the energy emitted in the visible spectrum by the display system placed in the cockpit.

The sources of illumination of the flight and display instruments which are used in aeronautics, lights, electroluminescent diodes, and the like, are not naturally compatible with the standards, emitting an excessively high level of light in the band in which the goggles are amplified. One means for reducing the interfering light energy emitted by the flying instruments in the band of optical frequencies of the goggles consists in optically filtering the source of illumination of the instruments in order to reduce this interfering energy received by the goggles.

An illumination compatible with night vision goggles or NVGs thus results from the combination of a source of visible light and of a filter. In other words, a specific light source, for example lights, electroluminescent diodes, and the like, will be combined with a filter suited to the characteristics of the light source in order to obtain a level of interfering light, in the optical band in which the goggles are amplified, compatible with the standards used.

The filters with which the sources of illumination of the flight instruments are combined are essentially colored films and sheets with a thickness which can vary according to the application. In the state of the art, the filters are obtained either by extruding and laminating a polymer or by polymerizing under hot conditions a mixture comprising at least one monomer and one dye. The filter obtained, usually in the form of a sheet with a side length of a few centimeters, is subsequently machined to adapt it to the shapes and dimensions of the source of illumination. Nevertheless, the methods for the manufacture of the filters compatible with the night vision goggles of the state of the art have a high manufacturing cost related in particular to the machining of the sheets of the filters necessary in order to adapt them to the instruments to be fitted with filters.

### SUMMARY OF THE INVENTION

In order to overcome the disadvantages of the filters of the state of the art compatible with night vision goggles, the invention provides a process for the manufacture of a light filter compatible with night vision goggles having at least the following stages:
preparation of a homogeneous solution comprising at least:
   one monomer;
   one dye;
   one photoinitiator;
photochemical crosslinking by ultraviolet radiation of the solution in the film form;
annealing the photocrosslinked film.

The dye exhibits a near infrared absorption.

In a first process for the manufacture of the filter, the solution comprises (in addition to the other components) a monomer from the family (A) of the diacrylates with the following chemical structure:

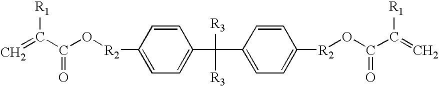

R₁ being: either CH₃ or H;

R₂ being: (CH₂-CH₂—O)ₙ;

R₃ being: either CH₃ or H or CF₃;

R₄ being: either CH₃ or H or CF₃;

n being an integer between 1 and 5

In a second manufacturing process, the solution comprises a monomer from the family (B) of the diacrylates with the following chemical structure:

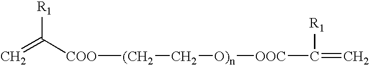

In other manufacturing processes, the solution comprises monomers from different families, for example a mixture of monomers from the families (A) and (B) described above.

In this case of a mixture of monomers in the solution, the amount of monomers from the two families is substantially identical.

### BRIEF DESCRIPTION OF DRAWINGS

The invention will be better understood with the help of implementational examples of light filters compatible with night vision goggles (NVGs) with reference to the appended figures, in which:

FIG. 1, already described, shows the various light sources received by night vision goggles;

FIG. 2 represents the transmission spectrum of a dye (Liqui-Kolor green) used in the process for the manufacture of the filter according to the invention;

FIG. 3 represents the absorption spectrum of another dye (Epolight 2057) used in the process for the manufacture of the filter according to the invention;

FIG. 4 represents a block diagram of a device for the irradiation by fluorescent tubes of the solution of the process according to the invention;

FIG. 5 represents the emission spectrum of the fluorescent tubes of FIG. 4 for the irradiation of the solution;

FIG. 6 represents another device for the irradiation of the solution;

FIG. 7 represents the relative intensity for emission of the lamp from Doctor Hönle as a function of the optical wavelength λ in nm;

FIG. 8 shows the optical transmission spectrum of the film obtained by the manufacturing process according to the invention.

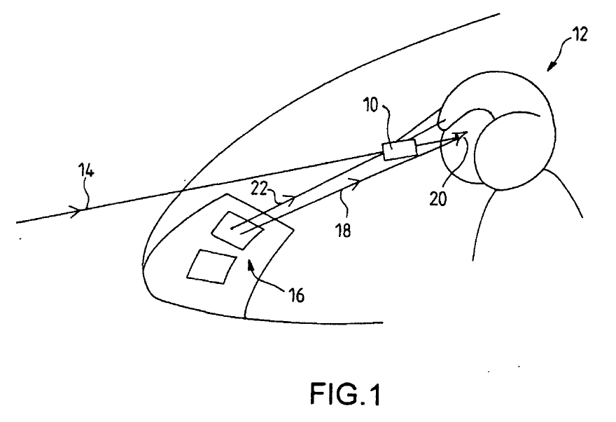

### DETAILED DESCRIPTION OF EMBODIMENTS

We will subsequently describe an example of the process for the manufacture of the light filter according to the invention from the photocrosslinking of a solution comprising a diacrylate, bisphenol A ethoxylate (1 EO/phenol) diacrylate, two dyes selected by the applicant company, namely copper perchlorophthalocyanine and Epolight 2057, and a photoinitiator, Darocure 1173, added to the solution in order to initiate the photocrosslinking.

Bisphenol A ethoxylate (1 EO/phenol) diacrylate is a liquid difunctional monomer sold by the company with the commercial name “Aldrich” under the reference 41,355-0, the chemical structure (C) of which is represented below:

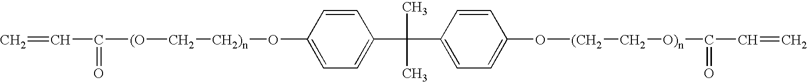

with Mₙ=424 g.mol⁻¹.

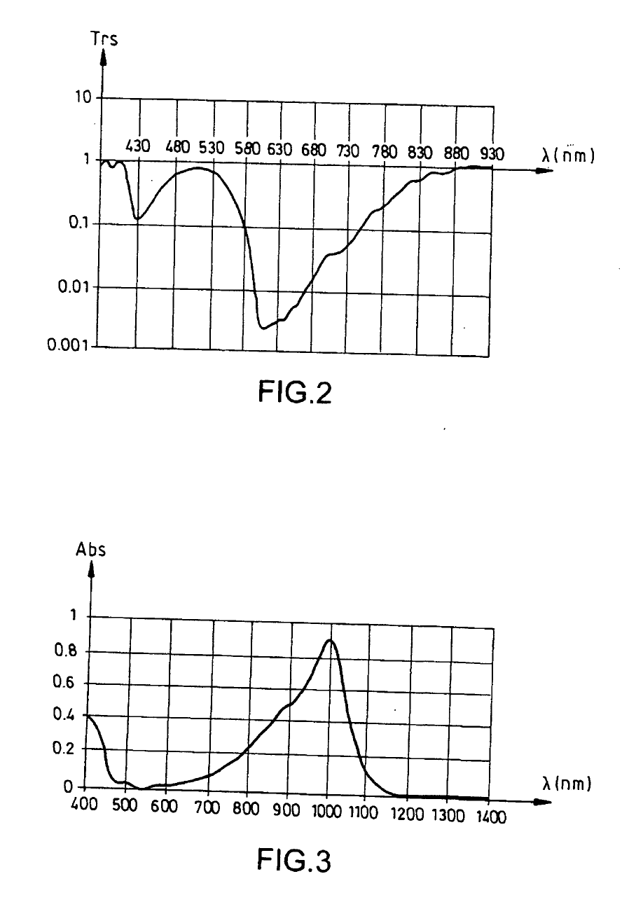

The copper perchlorophthalocyanine chosen for this manufacturing example is that which is provided in the form of a suspension in a relatively nonvolatile solvent and which is sold by the company with the commercial name “BASF” under the name of “Liqui-Kolor green”, the spectrum of optical transmission Trs as a function of the wavelength λ in nm of which is represented in FIG. 2.

Epolight 2057 is a powder sold by the company with the commercial name “Epolin Inc.”. FIG. 3 represents the spectrum for absorption Abs of Epolight 2057 as a function of the wavelength λ in nm.

The chemical structure (D) of Darocure 1173, sold by the company with the commercial name “Merck”, is represented below by its chemical structure:

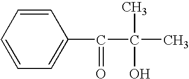

The manufacture of a filter according to the invention comprises at least the following stages:
first stage: preparation of a solution for producing, in this example, a film of rectangular shape with a thickness of 1 mm and a side length of a few cm. To this end, the components of the solution are introduced into a vessel according to the following amounts:
22.5 mg of Epolight 2057;
80 mg of “Liqui-Kolor green”;
900 mg of photoinitiator Darocure 1173;
10 g of bisphenol A ethoxylate (1 EO/phenol) diacrylate.

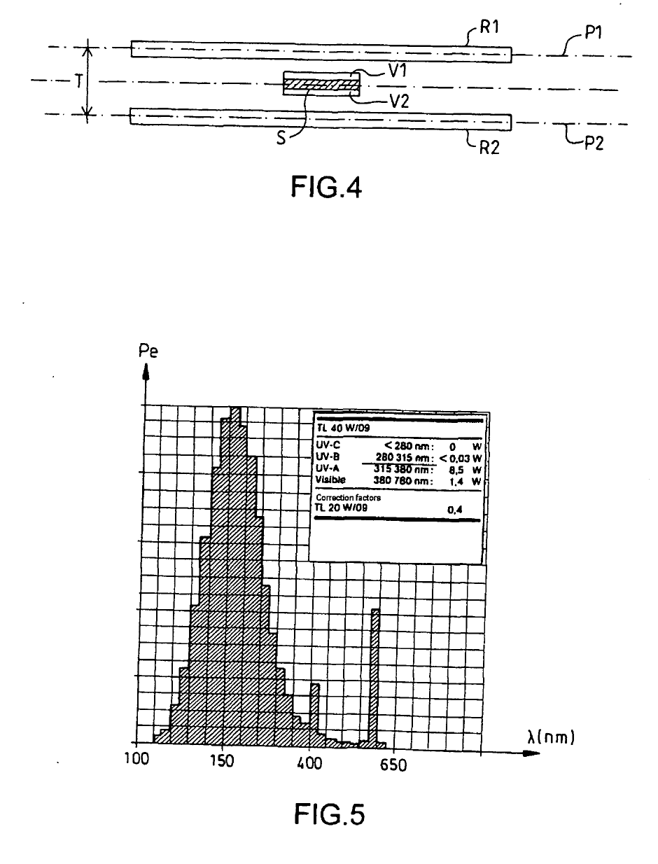

The solution is stirred using a magnetic bar until a homogeneous mixture is obtained. This mixing operation can last several hours.
second stage: photochemical crosslinking:
the solution produced during the first stage is introduced by capillary action between two parallel glass slides 1 mm apart and with dimensions substantially identical to those of the film to be produced, and then the solution between the two glass sheets is irradiated for 50 min with radiation emitted by two fluorescent tubes with the commercial reference TL40W/09N from the company with the commercial name “Philips”, according to an arrangement represented in FIG. 4.

FIG. 4 represents a block diagram of a device for the irradiation by fluorescent tubes of the solution of the process according to the invention.

The irradiation device of FIG. 4 comprises two rows of the fluorescent tubes R1, R2 positioned respectively according to two parallel planes P1 and P2 separated by a distance T of 8 cm.

The solution S between two glass sheets V1, V2 is positioned at an equal distance from the parallel planes P1, P2 and substantially towards the middle of the fluorescent tubes.

FIG. 5 represents the spectrum for emission Pe of the “Philips” fluorescent tubes with the commercial reference TL40W/09N, for the irradiation of the solution S, as a function of the optical wavelength λ in nm.

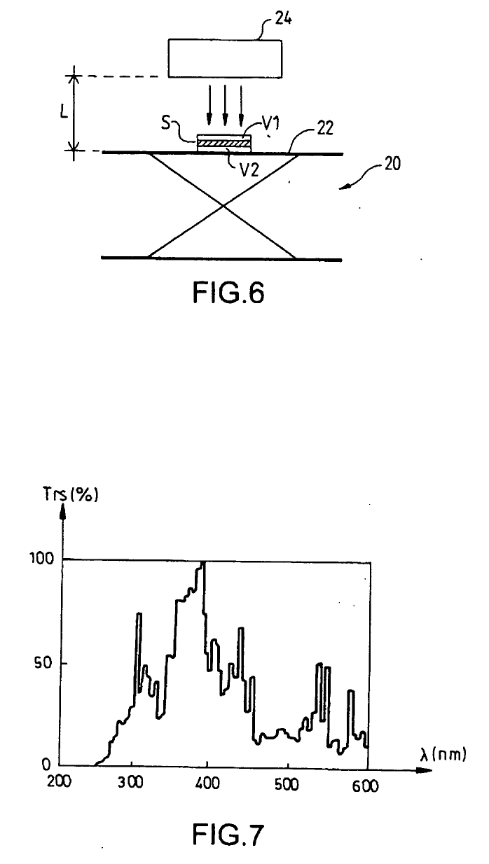

In another device for the irradiation of the solution S between the two glass sheets V1, V2, represented in FIG. 6, the source of radiation is a lamp from Doctor Hönle. The relative intensity for emission Trs as % of the lamp from Doctor Hönle as a function of the optical wavelength λ in nm is represented in FIG. 7.

The irradiation device of FIG. 6 comprises a support 20 having an irradiation face 22 supporting the glass sheets comprising the solution S to be irradiated and the lamp from Doctor Hönle 24, the radiation of which is directed towards the irradiation face 22.

The distance L between the support face and the lamp 24 can be adjusted in order to obtain the desired irradiation of the solution.

In a final stage which completes the process for the manufacture of the filter, the film resulting from the irradiation is heated at a temperature of 70° C. for twelve hours. This final stage provides curing of the film obtained, which is devoid of air bubbles and of good optical quality.

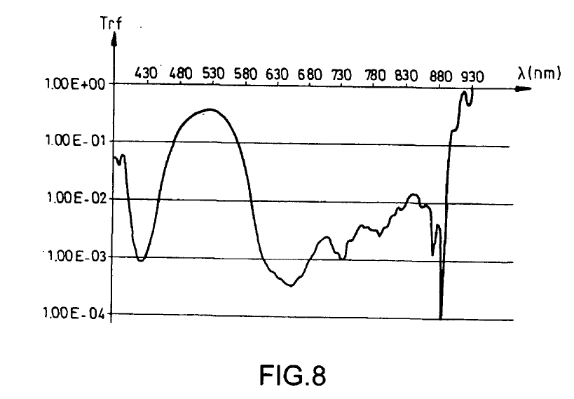

FIG. 8 shows the spectrum of optical transmission Trf of the film (or of the filter) obtained by the manufacturing process according to the invention as a function of the optical wavelength λ in nm.

The manufacturing process described is given by way of example and can be optimized. In particular, it is possible to vary the amount of photoinitiator, the nature of the lamps and the annealing conditions (time, temperature) in order to further reduce the manufacturing time.

The process for the manufacture of the light filter according to the invention has the advantage of making it possible to obtain filtering components of any shape using molds comprising the solution which assumes the shape of the mold, which makes it possible to dispense with the stages of machining the filters of the state of the art.

1. A process for the manufacture of a light filter compatible with night vision goggles comprising:
preparation of a homogeneous solution (S) including
one monomer;
one dye;
one photoinitiator;
photochemical crosslinking by ultraviolet radiation of the solution in the film form;
annealing the photocrosslinked film.

2-14. (canceled)

15. The process for the manufacture of a filter as claimed in claim 1, wherein the monomer is chosen from the family (A) of the diacrylates with the following chemical structure: 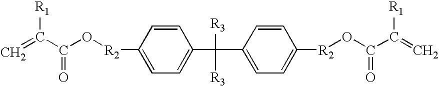
R₁ being: either CH₃ or H;
R₂ being: (CH₂-CH₂—O)ₙ;
R₃ being: either CH₃ or H or CF₃;
R₄ being: either CH₃ or H or CF₃;
n being an integer between 1 and 5

16. The process for the manufacture of a filter as claimed in claim 1, wherein the monomer is chosen from the family (B) of the diacrylates with the following chemical structure:

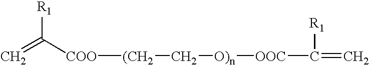

17. The process for the manufacture of a filter as claimed in claim 1, wherein the solution comprises monomers from different families.

18. The process for the manufacture of a filter as claimed in claim 17, wherein the amount of monomers from the two families is substantially identical.

19. The process for the manufacture of a filter as claimed in claim 1, wherein it is carried out by photocrosslinking a solution comprising:
a diacrylate, bisphenol A ethoxylate (1 EO/phenol) diacrylate;
two dyes, namely copper perchlorophthalocyanine and Epolight;
a photoinitiator, added to the solution in order to initiate the photocrosslinking.

20. The process for the manufacture of a filter as claimed in claim 19, wherein the bisphenol A ethoxylate (1 EO/phenol) diacrylate is a liquid difunctional monomer, the chemical structure (C) of which is represented below: 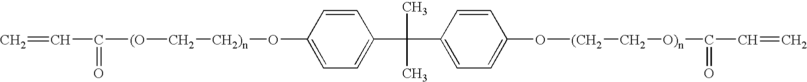
with Mₙ=424 g.mol⁻¹.

21. The process for the manufacture of a filter as claimed in claim 19, wherein the copper perchlorophthalocyanine is that which is provided in the form of a suspension in a relatively nonvolatile solvent.

22. The process for the manufacture of a filter as claimed in claim 19, wherein Epolight is a powder.

23. The process for the manufacture of a filter as claimed in claim 19, wherein the chemical structure of Darocure is:

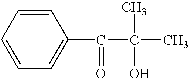

24. The process for the manufacture of a filter as claimed in claim 18, wherein it comprises at least the following stages:
first stage: preparation of a solution for producing a film with a thickness of 1 mm:
22.5 mg of Epolight 2057;
80 mg of a relatively nonvolatile solvent; 900 mg of photoinitiator;
g of bisphenol A ethoxylate (1 EO/phenol) diacrylate;
the solution being stirred using a magnetic bar until a homogeneous mixture is obtained;
second stage:
introduction of the solution by capillary action between two parallel glass slides (V1, V2) 1 mm apart;
third stage: photochemical crosslinking by irradiation of the solution between the two glass sheets for 50 min with radiation emitted by two fluorescent tubes.

25. The process for the manufacture of a filter as claimed in claim 1, wherein the irradiation device comprises two rows of fluorescent tubes respectively positioned according to two parallel planes separated by a distance of 8 cm, the solution between the two glass sheets being positioned at an equal distance from the parallel planes and substantially towards the middle of the fluorescent tubes.

26. The process for the manufacture of a filter as claimed in claim 1, wherein the source of radiation is a lamp, the irradiation device comprising a support having an irradiation face supporting the glass sheets comprising the solution to be irradiated, the radiation being directed towards the irradiation face.

27. The process for the manufacture of a filter as claimed in claim 1, wherein, in a final stage which completes the process for the manufacture of the filter, the film resulting from the irradiation is heated at a temperature of 70° C. for twelve hours.
